(19) United States
(12) Patent Application Publication
(10) Pub. No.: US 2024/0426058 A1
(43) Pub. Date: Dec. 26, 2024

(54) METHOD FOR PRODUCING DECORATIVE PAPER

(71) Applicant: SWISS KRONO TEC AG, Luzern (CH)

(72) Inventors: Frank OLDORFF, Schwerin (DE); Sebastian DICKE, Bantikow (DE)

(21) Appl. No.: 18/728,647

(22) PCT Filed: Jan. 13, 2023
(86) PCT No.: PCT/EP2023/050730

§ 371 Date: Jul. 12, 2024

(30) Foreign Application Priority Data
Jan. 14, 2022 (EP) 22151624.8

(51) Int. Cl. D21H 19/82; B41J 2/155; B41J 2/18; B41J 15/04; B41J 29/00; B41M 3/00; B41M 5/00; D21H 17/67; D21H 23/34; D21H 23/50; D21H 23/72

(52) U.S. Cl. CPC D21H 19/828; B41J 2/155; B41J 2/18; B41J 15/04; B41J 29/00; B41M 3/008; B41M 5/0017; D21H 17/675; D21H 23/34; D21H 23/50; D21H 23/72

(57) ABSTRACT

The invention relates to a method for producing decorative paper, in which a decorative design in printed onto a paper web. According to the method, a digital printing system is used, the paper web has a grammage of at least 45 g/m² and at most 65 g/m², a primer is applied to the paper web in a application amount of at least 4 g/m² and at most 6 g/m², preferably 5 g/m², prior to the decorative design being printed on, and the decorative design is printed on with at most 7.5 g/m² printing ink.

The invention relates to a method for producing a decorative paper in which a decoration is printed onto a paper web.

Decorative papers have been produced for many years, for example to create laminate panels, floor panels or wall and ceiling coverings, but also furniture boards. In the process, a desired decoration, such as a real wood decoration, is printed onto a paper web or paper sheet. This is then applied, for example, to a core, which is preferably a wood-based material panel. To this end, the printed paper is often impregnated with a synthetic resin or polyurethane and pressed with the core in a short-cycle press. Professionals have been familiar with the production of panels or boards from the prior art for many years.

Digital printing facilities, with which decorations can be printed on papers, have also been known for many years. So-called single-pass paper digital printing facilities, in which the paper to be printed only has to pass through the printing facility once, are used in the packaging industry, for example, to print packaging materials, such as cardboard boxes. However, the requirements for the print and the resulting decoration are considerably lower than for the production of decorative papers. This applies to both the quality of the individual print of the decoration and the reproducibility of the decorations, which are often produced in large quantities. Moreover, decorative papers with the same decoration are often produced in different batches, possibly with very large time intervals in between, meaning the demand on reproducibility is increased even further.

The problem is that the print result of the decoration applied to the paper web is influenced by a wide range of parameters. This relates to the paper used, the quantity and type of printing ink applied and, where applicable, the quantity and type of the primer used, which can also be referred to as a primer coating, but also to environmental factors such as humidity or temperature. Moreover, the parameters cannot be optimized independently of each other; rather, they have a mutual impact on each other.

The invention thus aims to further develop a method for producing a decorative paper in such a way that the best possible print result can be achieved.

The invention solves the task addressed by way of a method for producing a decorative paper, in which a decoration is printed onto a paper web, wherein during the method
a digital printing facility is used,
the paper web has a grammage of at least 45 g/m² and at most 65 g/m²,
prior to printing the decoration, a primer is applied to the paper web in an application quantity of at least 4 g/m² and at most 6 g/m², preferably 5 g/m²,
the decoration is printed with at most 7.5 g/m² of printing ink.

Due to the design of the method according to the invention, the decorative paper can be printed at a high quality, quickly, in industrial quantities and according to industrial requirements. At the same time, high quality is ensured in a cost-effective manner.

Preferably, the digital printing facility has a print width of at least 2050 mm and/or a web speed of at least 135 m/min and/or at least two print head rows with a resolution of at least 1200 dpi×1200 dpi at a web speed of 135 m/min and/or a resolution of at least 1200 dpi×600 dpi at a web speed of 270 m/min for each color used. In one embodiment, the digital printing facility has a resolution of 1200 dpi×600 dpi at a web speed of 270 m/min. This high speed is particularly advantageous for decorations with low ink consumption, i.e. especially light-colored and dense decorations, which preferably do not have much detail and can therefore be described as undemanding.

Preferably, the digital printing facility has an automatic roller bearer and/or automatic paper threading and/or an error monitoring system and/or a color monitoring system. The roller bearer makes it possible to change the paper web to be printed, which is delivered on a roll, without having to stop the digital printing facility. Automatic paper threading allows the paper to be changed quickly if required. With an error monitoring system and a color monitoring system, each of which has a camera or sensor, for example, with which the quality and/or colors of the print can be detected and determined, corrections to the print settings can be made if necessary and any low-quality products detected and removed from the production process. This reduces the frequency of complaints and the number of rejects.

Particularly preferably, the digital printing facility has an ink circulation system, preferably in the print head, so that the ink can be moved in order to avoid clogging of the print head nozzles and thus a malfunction of the print head. In a digital printing facility, the ink used to print the decoration is applied to the paper web in the form of many small drops. The drops are generated in the print head and subsequently applied to the paper web. Preferably, the so-called “waveform” with which the drops are generated can be adjusted and the digital printing facility has a user interface that can be used to perform this adjustment. The generation of the drops can thus be adapted to the ink and its properties. Fine adjustment options for density are particularly preferable so as to ensure an even print by means of the software contained in the digital printing facility.

Preferably, the paper web has a titanium dioxide content of less than 40%, preferably less than 35%, especially preferably less than 32% and more than 20%, preferably more than 23%, especially preferably more than 28%.

Due to the relatively small grammage of the paper used in the methods according to the present invention, an effective ratio of paper mass to its thickness is achieved, which produces good and favourable impregnated properties. The composition of the paper is selected in such a way that as many decorations as possible can be implemented on said paper, wherein the paper is moderately highly filled at the same time. More expensive types of paper should only be used for special embodiments, where other advantages prevail. For example, white paper, i.e. paper with a higher proportion of ash and/or titanium dioxide, is used if a very light decoration is to be printed that only requires a small amount of ink. This saves on costs, which often prevail over the higher costs caused by the more expensive paper.

The primer is preferably an active primer. An active primer contains substances that react with substances in the ink used during printing of the surface, for example the pigments. As a result, at least one part of the pigments contained in the ink is fixed to the printed surface and prevented from sinking into the printed paper. If such an active primer is used, a relatively small amount of primer is sufficient to achieve a better and more intense color image. Conversely, in the case of a passive primer, which can also be referred to as normal primer, the surface to be printed is covered. This makes it more difficult or even impossible for the pigments to penetrate the paper, which is also referred to “sinking”. Given that a chemical reaction with the components of the ink does not occur with such a passive primer, the surface to be printed must be as fully sealed as possible, so that a significantly larger quantity of primer must be used compared to an active primer. It is therefore more expensive to use a passive primer than an active primer. If less primer is used than the amount specified, a larger amount of ink has to be used for the decoration, which results in higher costs. However, using more primer than the amount specified means that no additional effect is created, meaning that primer is wasted. An active primer, which is preferably matched to the ink system, i.e. the different colored inks used, holds the ink pigments in the thin application layer of the primer and prevents or makes it more difficult for the pigments to sink into the paper, i.e. to penetrate it deeply. This reduces the ink required to create a desired color impression. Preferably, the primer is applied inline, i.e. within the printing facility during a single run of the paper. Preferably, a pressure chamber doctor blade with a ceramic roller with an indirect application rubber roller is used to achieve an even application across the entire print width. The ceramic anilox roller preferably has an 80 mm grid. This achieves the best possible application quantity of the primer. A ceramic roller is more durable than, for example, chrome-plated steel bodies, which can also be used.

Therefore, the primer is preferably applied by means of a pressure chamber doctor blade and a ceramic roller with an indirect application rubber roller, wherein the ceramic anilox roller preferably has an 80 mm grid.

The primer is preferably applied by means of the digital printing facility or in the digital printing facility.

In a preferred embodiment, the ink has a solvent content of at least 27% and at most 37%, preferably 32%, and/or a water content of at least 55% and at most 65%, preferably 60%, and/or a pigment content of 1%. The application quantity is matched to the primer quantity. Inks of the type described here have a solid material content and/or a pigment content that results in effective impregnability of the paper it is printed onto. This is especially advantageous in the production of decorative papers, in particular for laminate panels.

Advantageously, the digital printing facility is operated in a room with a room temperature of at least 22° C. and at most 24° C., preferably 23° C., and/or with a relative humidity of at least 53% and at most 57%, preferably 55%.

When a humidity of 55% is combined with a temperature of 23° C., the proportion of relative humidity is especially advantageous. The moisture content of the paper to be printed is also especially good as a result, i.e. it does not become too dry or to moist too quickly. This results in the development of fewer wrinkles in the printing facility and thus a better print quality, particularly at high speeds. Even at high speeds, there is a reduced risk that the paper to be printed will tear. It is particularly preferably if the room temperature is kept at a constant in terms of time. This means that the temperature of the paper, ink and/or primer is also stable, resulting in stable application properties. Too low a temperature leads to negative drying properties, which may result, for example, in an impure print image. The relatively low grammage and/or the low application quantity or primer and/or ink ensure that there are not too many pigments and/or solid materials in the thin paper after drying. This ensures improved resin absorption during subsequent impregnation and therefore better adhesion on the plate during pressing.

In a first specific embodiment example, at a producer for laminate floorboards, printed decorative paper is produced on a paper digital printing facility. The working width of the digital printing facility is 2070 mm. It has a double row of print heads with a resolution of 1200 dpi×1200 dpi and ink circulation in the print head. The speed of the paper web within the digital printing facility is 135 m/min and only one type of decorative paper is printed, which is used, however, in two different grammages of 50 g/m² and 65 g/m². A water-based ink and the CRYK color system are used for printing. Within the digital printing facility, an active primer is applied inline with a ceramic anilox roller at a rate of 5 g/m². In the room where the printing happens, the humidity is at 55% and the air temperature is 23° C. An average of 4 g/m² ink application is used for the decorations. Under these conditions, a quantity of more then 100 million m² of laminate can be produced on a basis of digitally printed decorative paper per year. This corresponds to more than 6000t of printed decorative paper. At a width of 2070 mm and 300 working days on which decorative paper is printed round the clock, this corresponds to approximately 120 million m². Downtimes have already been accounted for in this case. The materials used and the quantities thereof allow for effective further processing, for example impregnation or impregnate adhesion to the HDF board, which is used as a core. In this case, this results in a high-quality end product, with less than 1% waste and complaints. The small number of paper types enables, among other things, a low purchasing price and few downtimes caused by changing the paper or formula. The high annual quantity, the low consumption of production materials, low quantities of waste, the small proportion of complaints, and the production materials purchased in large quantities for a low price result in a very competitive laminate, which can be offered for a lower price than with other combinations in digital decorative paper printing.

Preferably, the decorative paper is printed in a single pass procedure. Here, the paper to be printed only has to pass through the digital printing facility once, even if multiple colors are to be printed, for example, and/or a primer is applied before printing.

Particularly preferably, at least some, but preferably all, print heads have an ink circulation system. This reduces the risk and number of blockages in and/or in front of the print head and especially in and/or in front of the nozzles of the print head through which the ink is applied to the paper.

The print intensity of print heads is preferably adjustable. It is particularly preferable if the print intensity of the print heads can be adjusted individually and, advantageously, independently of one another. Particularly preferably, this is possible for each print head.

Alternatively or additionally, the print intensity of groups of print heads is adjustable. A group of print heads preferably comprises between 5 and 10 print heads. Preferably, each of the print heads belongs to at least one group, especially preferably to precisely one group.

The easiest way to set the print intensity is to adjust the amount of ink that is applied to the paper to be printed by the respective print head. The adjustment is preferably done using a software of the digital printing facility, which also preferably controls the digital printing facility.

1. A method for producing a decorative paper, comprising:
applying a primer to a paper web that has a grammage of at least 45 g/m² and at most 65 g/m², wherein the primer is applied to the paper web in an application quantity of at least 4 g/m² and at most 6 g/m², and then
printing a decoration on the paper web using a digital printing facility, wherein the printing is performed is printed with at most 7.5 g/m² of printing ink.

2. The method according to claim 1, wherein
the digital printing facility has
a print width of at least 2050 mm and/or
a web speed of at least 135 m/min and/or
at least two print head rows with a resolution of at least 1200 dpi×1200 dpi at a web speed of 135 m/min and/or
a resolution of at least 1200 dpi×600 dpi at a web speed of 270 m/min for each color used.

3. The method according to claim 1 wherein the digital printing facility has
an automatic roller bearer and/or
automatic paper threading and/or
an error monitoring system and/or
a color monitoring system.

4. The method according to claim 1 wherein the paper web has a titanium dioxide content of less than 40 and more than 20%.

5. The method according to claim 1 wherein the primer is an active primer.

6. The method according to claim 1 wherein the primer is applied by pressure chamber doctor blade and a ceramic roller with an indirect application rubber roller.

7. The method according to claim 1 wherein the primer is applied by the digital printing facility or in the digital printing facility.

8. The method according to claim 1 wherein the printing ink comprises a solvent content of at least 27% and at most 37%, and/or a water content of at least 55% and at most 65%, and/or a pigment content of 1%.

9. The method according to claim 1 wherein the digital printing facility is operated in a room with
a room temperature of at least 22° C. and at most 24° C., and/or
a relative humidity of at least 53% and at most 57.

10. The method according to claim 1 wherein the decorative paper is printed in a single pass procedure.

11. The method according to claim 1 wherein the digital printing facility comprises a plurality of print heads, and wherein at least some of the print heads have an ink circulation system.

12. The method according to claim 1 wherein the digital printing facility comprises a plurality of print heads, and wherein a print intensity of individual print heads of the plurality of print heads and/or a print intensity of groups of print heads of the plurality of print heads is adjustable.

13. The method according to claim 12, wherein a group of print heads of the groups of print heads contains 5 to 10 print heads.

14. The method according to claim 4 wherein the titanium dioxide content is from 28-32%.
